(19) United States
(12) Patent Application Publication
(10) Pub. No.: US 2026/0331547 A1
(43) Pub. Date: Oct. 22, 2026

(54) Electrolyte Composition for Redox Flow Battery and Redox Flow Battery Comprising Same

(71) Applicant: Foundation for Research and Business, Seoul National University of Science and Technology, Seoul (KR)

(72) Inventors: Yong Chai Kwon, Seoul (KR); Chan Ho Noh, Seoul (KR); Min Gyu Shin, Seoul (KR)

(21) Appl. No.: 19/104,529

(22) PCT Filed: Aug. 17, 2023
(86) PCT No.: PCT/KR2023/012162

§ 371 Date: Feb. 18, 2025

(30) Foreign Application Priority Data
Aug. 18, 2022 (KR) 10-2022-0103102

(51) Int. Cl. H01M 8/18

(52) U.S. Cl. CPC H01M 8/188; H01M 2300/0002

(57) ABSTRACT

The present invention relates to an electrolyte composition for a redox flow battery and a redox flow battery comprising same. An electrolyte composition for a redox flow battery according to an embodiment of the present invention comprises: an iodide salt and a cyclodextrin (CD)-based additive.

### TECHNICAL FIELD

The present disclosure relates to an electrolyte composition for a redox flow battery (RFB), and an RFB including the same.

### BACKGROUND ART

Redox flow batteries (RFBs) are secondary batteries that store electrical energy through a charging/discharging process using active materials with different electrochemical potentials.

As RFBs may control energy and power separately, the RFBs have the advantages of excellent design flexibility, relatively high safety, and long lifespan. However, the RFBs have insufficient energy density and the cost of transition metals used as active materials is high, making it difficult to be price competitive compared to commercial battery technology.

As an alternative, there was an attempt to use relatively inexpensive iodine (I, atomic number 53) as an active material in the RFB, however, there was a problem that an iodide film that does not dissolve in an electrolyte is generated during charging/discharging of the batteries, which blocks a flow path of the flow battery and reduces the performance of the battery.

### DISCLOSURE OF THE INVENTION

### Technical Goals

The present disclosure is made to solve the above-mentioned problems and an object thereof is to provide an electrolyte for a redox flow battery (RFB) including an additive that may continuously remove an iodide film generated during charging/discharging of a battery from a surface and a flow path of an electrode.

Another object of the present disclosure is to provide an RFB that increases flow stability of the RFB and stably operates by applying the electrolyte for the RFB.

However, technical goals to be achieved are not limited to those described above, and other goals not mentioned above can be clearly understood by one of ordinary skill in the art from the following description.

### Technical Solutions

An electrolyte composition for a redox flow battery (RFB) includes iodide (iodine) salt, and a cyclodextrin (CD)-based additive.

In an embodiment, the iodide salt may include at least one selected from the group consisting of iodide salt of an alkali metal, n-methylimidazolium iodide (iodine), n-ethylimidazolium iodide, 1-benzyl-2-methylimidazolium iodide, 1-ethyl-3-methylimidazolium iodide, 1-butyl-3-methylimidazolium iodide, 1-methyl-3-propylimidazolium iodide, 1-methyl-3-isopropylimidazolium iodide, 1-methyl-3-butylimidazolium iodide, 1-methyl-3-isobutylimidazolium iodide, 1-methyl-3-s-butylimidazolium iodide, 1-methyl-3-pentylimidazolium iodide, 1-methyl-3-isopentylimidazolium iodide, 1-methyl-3-hexylimidazolium iodide, 1-methyl-3-isohexyl imidazolium iodide, 1-methyl-3-actylimidazolium iodide, 1,2-dimethyl-3-propylimidazolium iodide, 1-ethyl-3-isopropylimidazolium iodide, 1-propyl-3-propylimidazolium iodide, and 1-propyl-3-methylimidazolium iodide.

In an embodiment, the iodide salt may be present in an amount of 0.01 M to 7 M in the electrolyte composition for the RFB.

In an embodiment, the CD-based additive may include at least one selected from the group consisting of α-CD, β-CD, γ-CD, and a derivative thereof.

In an embodiment, the CD-based additive may be present in an amount of 0.01 M to 2.0 M in the electrolyte composition for the RFB.

In an embodiment, the CD-based additive may form a complex with an oxidizing species in the iodide salt to remove an iodide (iodine) film of the oxidizing species.

An RFB includes a positive electrode cell including a positive electrode and a positive electrode electrolyte, a negative electrode cell including a negative electrode and a negative electrode electrolyte, and an ion exchange membrane positioned between the positive electrode cell and the negative electrode cell, and the positive electrode electrolyte is the electrolyte composition for the RFB according to an embodiment of the present disclosure.

### Effects of the Invention

An electrolyte composition for a redox flow battery (RFB) of an embodiment of the present disclosure may continuously remove an iodide film generated during charging/discharging of a battery from a surface and a flow path of an electrode by including cyclodextrin (CD) as an additive.

The RFB according to an embodiment of the present disclosure may increase flow stability of the RFB and stably operate by applying the electrolyte for the RFB including CD as an additive.

### BRIEF DESCRIPTION OF DRAWINGS

FIG. 1 is a diagram illustrating a) a chemical structural formula of cyclodextrin (CD) and b) a three-dimensional (3D) structure of CD according to an embodiment of the present disclosure.

FIG. 2 is a diagram illustrating the principle of iodide film removal of CD according to an embodiment of the present disclosure.

FIG. 3 is a diagram illustrating redox reactivity of iodide according to presence or absence of hydroxypropyl-β-cyclodextrin (HP-β-CD) measured by cyclic voltammetry (CV) according to an example and a comparative example of the present disclosure.

FIG. 4 is a diagram illustrating redox reactivity of iodide according to presence or absence of HP-β-CD measured on an electrode rotating at 1,000 rpm according to an example of the present disclosure.

FIG. 5 is a graph of cycling capacity of an iodide flow battery according to whether CD is included according to an example and a comparative example of the present disclosure.

FIG. 6 shows a charge/discharge curve of an iodide flow battery without CD according to a comparative example of the present disclosure.

FIG. 7 is a charge/discharge curve of an iodide flow battery including CD according to an example of the present disclosure.

FIG. 8 is a) a photograph of an electrode of an iodide battery without CD, and b) a photograph of an electrode of an iodide battery including CD according to the present disclosure.

### BEST MODE FOR CARRYING OUT THE INVENTION

Hereinafter, embodiments will be described in detail with reference to the accompanying drawings. However, various alterations and modifications may be made to the embodiments. Here, the embodiments are not construed as limited to the disclosure. The embodiments should be understood to include all changes, equivalents, and replacements within the idea and the technical scope of the disclosure.

The terminology used herein is for the purpose of describing particular embodiments only and is not to be limiting of the embodiments. The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms including technical and scientific terms used herein have the same meaning as commonly understood by one of ordinary skill in the art to which the embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

When describing the embodiments with reference to the accompanying drawings, like reference numerals refer to like components and a repeated description related thereto will be omitted. In the description of embodiments, detailed description of well-known related structures or functions will be omitted when it is deemed that such description will cause ambiguous interpretation of the present disclosure.

In addition, terms such as first, second, A, B, (a), (b), and the like may be used to describe components of the embodiments. These terms are used only for the purpose of discriminating one component from another component, and the nature, the sequences, or the orders of the components are not limited by the terms.

The same name may be used to describe an element included in the embodiments described above and an element having a common function. Unless otherwise mentioned, the descriptions on the embodiments may be applicable to the following embodiments and thus, duplicated descriptions will be omitted for conciseness.

Hereinafter, an electrolyte composition for a redox flow battery (RFB) of the present disclosure and an RFB including the same will be described in detail with reference to embodiments and drawings. However, the present disclosure is not limited to the embodiments and drawings.

An electrolyte composition for the RFB according to an embodiment of the present disclosure includes an iodide salt; and a cyclodextrin (CD)-based additive.

Since the electrolyte composition for the RFB according to an embodiment of the present disclosure includes CD as an additive, it may be possible to continuously remove an iodide film generated during charging/discharging of a battery from a surface and a flow path of an electrode.

In an embodiment, the iodide salt may contain iodide molecules (I₂) and I⁻. For example, an iodide-based oxidizing/reducing species may be formed from the iodide salt. For example, the iodide-based oxidizing/reducing species may contain I⁻/I₃⁻.

According to an embodiment, the iodide salt may contain at least one selected from the group consisting of, for example, iodide salt of an alkali metal such as LiI, NaI, or KI, n-methylimidazolium iodide, n-ethylimidazolium iodide, 1-benzyl-2-methylimidazolium iodide, 1-ethyl-3-methylimidazolium iodide, 1-butyl-3-methylimidazolium iodide, 1-methyl-3-propylimidazolium iodide, 1-methyl-3-isopropylimidazolium iodide, 1-methyl-3-butylimidazolium iodide, 1-methyl-3-isobutylimidazolium iodide, 1-methyl-3-s-butylimidazolium iodide, 1-methyl-3-pentylimidazolium iodide, 1-methyl-3-isopentylimidazolium iodide, 1-methyl-3-hexylimidazolium iodide, 1-methyl-3-isohexylimidazolium iodide, 1-methyl-3-actylimidazolium iodide, 1,2-dimethyl-3-propylimidazolium iodide, 1-ethyl-3-isopropylimidazolium iodide, 1-propyl-3-propylimidazolium iodide, and 1-propyl-3-methylimidazolium iodide.

In an embodiment, the iodide salt may be present in an amount of 0.01 M to 7 M; 0.01 M to 6 M; 0.01 M to 5 M; 0.01 M to 4 M; 0.01 M to 3 M; 0.01 M to 2 M; 0.01 M to 1 M; 0.01 M to 0.1 M; 0.1 M to 7 M; 0.1 M to 6 M; 0.1 M to 5 M; 0.1 M to 4 M; 0.1 M to 3 M; 0.1 M to 2 M; 0.1 M to 1 M; 1 M to 7 M; 1 M to 6 M; 1 M to 5 M; 1 M to 4 M; 1 M to 3 M; 1 M to 2 M; 3 M to 7 M; 3 M to 6 M; 3 M to 5 M; 3 M to 4 M; 5 M to 7 M; or 6 M to 7 M in the electrolyte composition for the RFB. When the amount of the iodide salt exceeds 0.01 M in the electrolyte composition for the RFB, a problem of clogging of a flow path of the RFB may occur.

In an embodiment, the CD-based additive may contain at least one selected from the group consisting of α-CD, β-CD, γ-CD, and a derivative thereof.

For example, the derivative of the β-CD may include at least one selected from the group consisting of hydroxypropyl-β-CD (HP-β-CD), dimethyl-β-CD (DM-β-CD), 2-hydroxyethyl-β-CD (2-HE-β-CD), trimethyl-β-CD (TM-β-CD), sulfobutylether-β-CD (SBE-β-CD), and randomly methylated β-CD.

For example, the derivative of the γ-CD may include at least one selected from the group consisting of 2-HP-γ-CD, acetyl-γ-CD, peracetyl-γ-CD, and SBE-γ-CD.

In an embodiment, the CD-based additive may be present in an amount of 0.01 M to 2.0 M; 0.01 M to 1.8 M; 0.01 M to 1.5 M; 0.01 M to 1.3 M; 0.01 M to 1.0 M; 0.01 M to 0.1 M; 0.1 M to 2.0 M; 0.1 M to 1.8 M; 0.1 M to 1.5 M; 0.1 M to 1.3 M; 0.1 M to 1.0 M; 0.3 M to 2.0 M; 0.3 M to 1.8 M; 0.3 M to 1.5 M; 0.3 M to 1.3 M; 0.3 M to 1.0 M; 0.5 M to 2.0 M; 0.5 M to 1.8 M; 0.5 M to 1.5 M; 0.5 M to 1.3 M; 0.5 M to 1.0 M; 1.0 M to 2.0 M; 1.0 M to 1.8 M; 1.0 M to 1.5 M; 1.0 M to 1.3 M; 1.0 M to 1.0 M; 1.5 M to 2.0 M; 1.5 M to 1.8 M; or 1.8 M to 2.0 M in the electrolyte composition for the RFB. When the amount of the CD-based additive is less than 0.01 M in the electrolyte composition for the RFB, a problem of not exhibiting the effect of the additive may occur, and when the amount thereof exceeds 2.0 M, a problem of the additive that does not dissolve and precipitates may occur.

In an embodiment, the CD-based additive may form a complex with an oxidizing species in the iodide salt to remove an iodide film of the oxidizing species.

In general, a redox reaction and a chemical reaction of iodide are as follows:

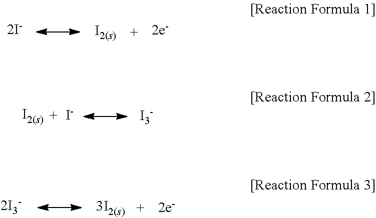

Reaction Formula 1 is related to a redox reaction, Reaction Formula 2 is related to a chemical reaction, and Reaction Formula 3 is related to a redox reaction.

The I₂₍ₛ₎ generated in these reactions is generated in the form of a film of a nonconductor on the surface of the electrode during an oxidation reaction of I-ions, blocks the flow path of the electrode, and acts as a resistor, degrading the overall performance of the battery. Therefore, it is important to continuously remove this iodide film to stably maintain the performance of an iodide flow battery.

In the present disclosure, the CD-based additive is included as an additive capable of removing such an iodide film.

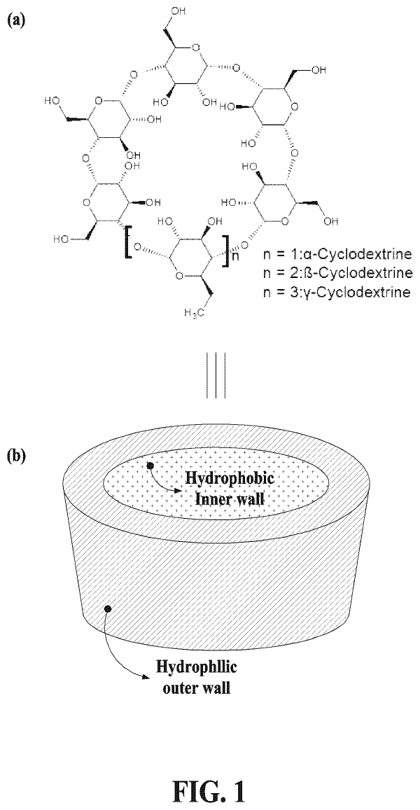

FIG. 1 is a diagram illustrating a) a chemical structural formula of CD and b) a three-dimensional (3D) structure of CD according to an embodiment of the present disclosure.

I₂₍ₛ₎ is classified as a nonpolar molecule because it has a symmetrical structure. An electrolyte of the iodide flow battery is a polar electrolyte because it is based on water. Therefore, when CD-based organic molecules that may accommodate nonpolar molecules inside and may dissolve well in an aqueous electrolyte due to the polarity on the outside are used as the additive, it may be possible to continuously move an iodide film generated on the surface of the electrode to the electrolyte.

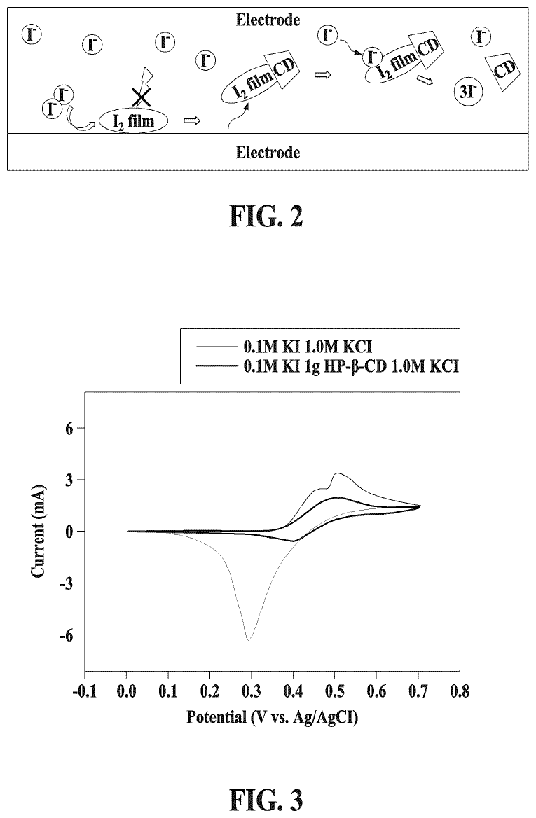

FIG. 2 is a diagram illustrating the principle of iodide film removal of CD according to an embodiment of the present disclosure.

Referring to FIG. 2, the iodide film transferred to the electrolyte meets extra I− ions again and changes into polar I₃⁻ molecules through the reaction of Reaction Formula 2, and the polar I₃⁻ molecules are separated from the CD. The CD, which has lost its internal receptor (here, the iodide film), may continuously remove the iodide film formed on the surface of the electrode, and this may serve as an additive capable of improving the continuous battery flow clogging phenomenon even with a small amount of CD compared to the amount of iodide.

An RFB according to another embodiment of the present disclosure includes a positive electrode cell including a positive electrode and a positive electrode electrolyte; a negative electrode cell including a negative electrode and a negative electrode electrolyte; and an ion exchange membrane positioned between the positive electrode cell and the negative electrode cell, and the positive electrode electrolyte is the electrolyte composition for the RFB according to an embodiment of the present disclosure.

The RFB according to an embodiment of the present disclosure may increase the flow stability of the RFB and operate stably by applying an electrolyte for an RFB containing CD as an additive.

Hereinafter, the present disclosure will be described in detail with reference to the following example and comparative example. However, the technical idea of the present disclosure is not limited or restricted thereto.

### EXAMPLE

### Iodide Electrolyte Composition Containing HP-β-CD

To confirm the electrode surface formation reaction of the iodide film (I₂₍ₛ₎) and the removal effect by CD, an electrochemical experiment was conducted using a three-electrode cell. A method for producing an iodide electrolyte composition containing CD is as follows.
1. 0.332 g of KI was dissolved in 15 ml of deionized water (DIW).
2. 1.5 g of KCl was dissolved in the solution.
3. 1 g of 2-HP-β-CD was dissolved in the solution.
4. DIW was added to the solution to adjust the volume to 20 ml.
(Aqueous solution of 0.1 M KI 1 g 2-HP-β-CD 1.0 M KCl)

### COMPARATIVE EXAMPLE

Iodide Electrolyte Composition without HP-β-CD

A solution of 0.1 M KI 1.0 M KCl without HP-β-CD was prepared to produce an iodide electrolyte composition.

The reactivity was measured by cyclic voltammetry (CV) using iodide electrolyte compositions produced according to the example and the comparative example of the present disclosure. FIG. 3 is a diagram illustrating redox reactivity of iodide according to presence or absence of HP-β-CD measured by CV according to an example and a comparative example of the present disclosure.

Referring to FIG. 3, as a result of measuring the reactivity by CV for the comparative example, two oxidation peaks (reactions of [Reaction Formula 1] and [Reaction Formula 3] in order) were shown, and a reduction peak larger than the oxidation peak was shown. This implies that an adsorbate (iodide film) whose diffusion rate is treated as infinite is generated on the surface of the electrode. On the other hand, in the CV reactivity experiment of the experimental group, only one oxidation peak and one reduction peak corresponding to [Reaction Formula 1] were shown.

The CV measurement experiment was conducted using the iodide electrolyte compositions produced according to the example and the comparative example of the present disclosure while rotating the electrode at 1000 revolutions per minute (rpm).

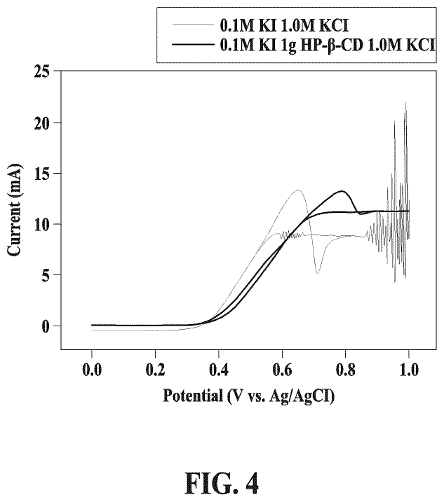

FIG. 4 is a diagram illustrating redox reactivity of iodide according to presence or absence of HP-β-CD measured on an electrode rotating at 1,000 rpm according to Example 1 and Comparative Example 1 of the present disclosure.

The electrode is rotated to maximize a mass transfer rate of ions by forming forced convection. As the CV measurement result of Comparative Example 1, to which the electrode rotation is added, a sharp current reduction peak was shown at 0.7 V (vs. Ag/AgCl). This is because a reactant may not be supplied as the iodide film, which is an nonconductor, is formed on the surface of the electrode. On the other hand, the data of the experimental group showed only a slight peak near-0.85 V (vs. Ag/AgCl). This implies that the CD added in Example 1 for the purpose of removing the iodide film is working effectively.

### [Test Example] RFB

The effect of the CD on the iodide film removal under actual battery operating conditions was evaluated. A battery electrolyte was configured to contain an iodide solution with a stage of charge (SOC) of 50%, and a symmetric cell experiment was conducted using this solution. The preparation of the battery electrolyte with the SOC of 50% containing CD is as follows.
1. 0.64 g of I₂₍ₛ₎ was dissolved in 15 ml of DIW.
2. 0.83 g of KI was dissolved in the solution.
3. 1.07 g of NH4Cl was dissolved in the solution.
4. 1 g of HP-β-CD was dissolved in the solution.
5. DIW was added to the solution to adjust the volume to 20 ml.
(Aqueous solution of 0.125 M I₂ 0.25 M KI 1 g 2-hydroxypropyl-b-cyclodextrin 1.0 M NH₄Cl)

For a comparative example, a solution of 0.125 M I₂ 0.25 M KI 1.0 M NH4Cl without HP-β-CD was prepared.

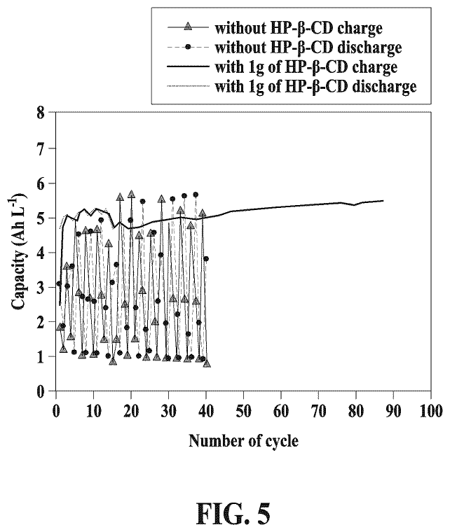

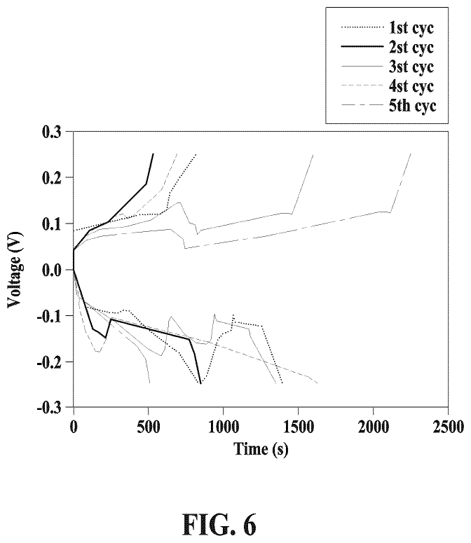

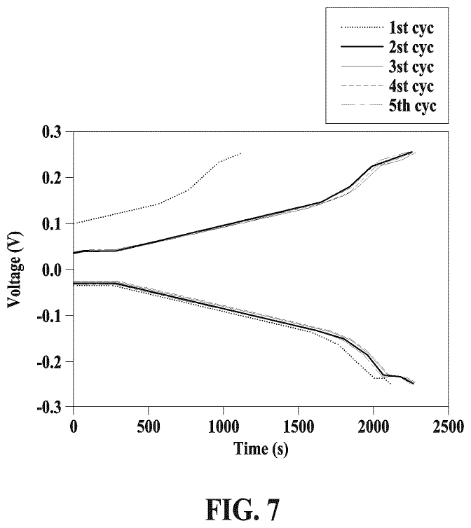

FIG. 5 is a graph of cycling capacity of an iodide flow battery according to whether CD is included according to an example and a comparative example of the present disclosure, FIG. 6 shows a charge/discharge curve of an iodide flow battery without CD according to a comparative example of the present disclosure, and FIG. 7 is a charge/discharge curve of an iodide flow battery including CD according to an example of the present disclosure.

Referring to FIGS. 5 to 7, as a result of the operation of the battery using the iodide electrolyte composition, in the comparative example without CD, the iodide film was formed on the surface of the electrode during the operation of the battery, and a rapid increase in resistance or clogging of the flow path occurred, making it difficult to operate the battery consistently.

In contrast, when the flow battery including CD was operated, excellent cycling reproducibility was achieved, and phenomena such as a rapid increase in resistance or clogging of the flow path caused by the iodide film did not occur at all.

This implies that CD effectively performs only the removal of the iodide film in the charge/discharge state of the battery, and has no effect on the capacity of the battery at all.

After the flow battery experiment ended, the state of the electrode was observed.

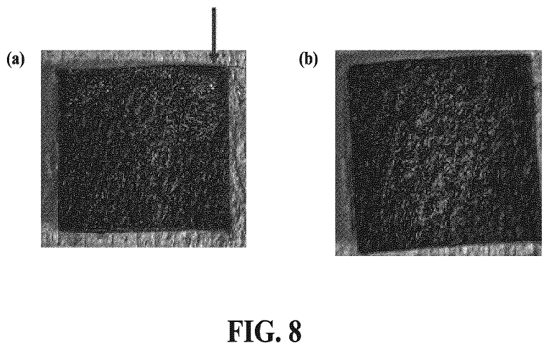

FIG. 8 is a) a photograph of an electrode of an iodide battery without CD, and b) a photograph of an electrode of an iodide battery including CD according to the present disclosure.

Referring to FIG. 8, in the electrode used in the comparative example experiment in a) of FIG. 8, an iodide film generated at the bottom of an arrow that may be observed with the naked eye was present, and in the battery using an electrolyte containing CD in b), no iodide film was observed.

Therefore, it was confirmed that using CD as an additive to the electrolyte is an effective method to suppress the formation of an iodide film that may occur during charging/discharging of an iodide battery and to secure the flow stability of the iodide battery.

In the related art, it was difficult to control the iodide film generated during charging/discharging of the battery, and thus, the freedom of capacity design, which is an advantage of flow batteries, was lost and only a limited capacity was able to be used. The method of using CD according to the present disclosure is a technology that enables the freedom of capacity design, which is the original purpose of flow batteries, and at the same time, since it may secure the flow stability of iodide flow batteries, it may also provide economic benefits in terms of a battery management system (BMS). In addition, even if the amount of CD in the electrolyte is smaller than the amount of iodide, it is expected that there will be no significant impact on the cost increase of the battery due to the use of the additive because the iodide film formed on the electrode surface may be continuously removed.

Since the iodide electrolyte containing the additive developed in the present disclosure may secure the flow stability of the battery, the system used in the RFB in the related art may be used as is. Therefore, if a relatively inexpensive iodide electrolyte may be used in the RFB market, which has been stagnant due to the high cost of the electrolyte in the related art, it is expected that explosive growth will be achieved in the RFB market.

Also, adding CD to the iodide electrolyte may secure the flow stability of the electrolyte.

While the embodiments are described with reference to drawings, it will be apparent to one of ordinary skill in the art that various alterations and modifications in form and details may be made in these embodiments without departing from the spirit and scope of the claims and their equivalents. For example, suitable results may be achieved if the described techniques are performed in a different order, and/or if components in a described system, architecture, device, or circuit are combined in a different manner, and/or replaced or supplemented by other components or their equivalents.

Therefore, other implementations, other embodiments, and equivalents to the claims are also within the scope of the following claims.

1. An electrolyte composition for a redox flow battery (RFB) comprising:
iodide salt; and
a cyclodextrin (CD)-based additive.

2. The electrolyte composition for the RFB of claim 1, wherein
the iodide salt comprises at least one selected from the group consisting of iodide salt of an alkali metal, n-methylimidazolium iodine, n-ethylimidazolium iodine, 1-benzyl-2-methylimidazolium iodine, 1-ethyl-3-methylimidazolium iodine, 1-butyl-3-methylimidazolium iodine, 1-methyl-3-propylimidazolium iodine, 1-methyl-3-isopropylimidazolium iodine, 1-methyl-3-butylimidazolium iodine, 1-methyl-3-isobutylimidazolium iodine, 1-methyl-3-s-butylimidazolium iodine, 1-methyl-3-pentylimidazolium iodine, 1-methyl-3-isopentylimidazolium iodine, 1-methyl-3-hexylimidazolium iodine, 1-methyl-3-isohexyl imidazolium iodine, 1-methyl-3-actylimidazolium iodine, 1,2-dimethyl-3-propylimidazolium iodine, 1-ethyl-3-isopropylimidazolium iodine, 1-propyl-3-propylimidazolium iodine, and 1-propyl-3-methylimidazolium iodine, and
the iodide salt is present in an amount of 0.01 M to 7 M in the electrolyte composition for the RFB.

3. The electrolyte composition for the RFB of claim 1, wherein
the CD-based additive comprises at least one selected from the group consisting of α-CD, β-CD, γ-CD, and a derivative thereof, and
the CD-based additive is present in an amount of 0.01 M to 2.0 M in the electrolyte composition for the RFB.

4. The electrolyte composition for the RFB of claim 1, wherein the CD-based additive forms a complex with an oxidizing species in the iodide salt to remove an iodine film of the oxidizing species.

5. A redox flow battery (RFB) comprising:
a positive electrode cell comprising a positive electrode and a positive electrode electrolyte;
a negative electrode cell comprising a negative electrode and a negative electrode electrolyte; and
an ion exchange membrane positioned between the positive electrode cell and the negative electrode cell,
wherein the positive electrode electrolyte is the electrolyte composition for the RFB of any one of claim 1.
